(19) United States
(12) Patent Application Publication
(10) Pub. No.: US 2026/0259417 A1
(43) Pub. Date: Sep. 3, 2026

(54) EXTENDED REALITY HEADSET WITH SHARED OCULAR REGION SENSOR

(71) Applicant: QUALCOMM Incorporated, San Diego, CA (US)

(72) Inventors: Chiranjib CHOUDHURI, Bangalore (IN); Michel Adib SARKIS, San Diego, CA (US); Sandeep Kanakapura LAKSHMIKANTHA, Bangalore (IN); Ajit Deepak GUPTE, Bangalore (IN); Ning BI, San Diego, CA (US)

(21) Appl. No.: 19/158,029

(22) PCT Filed: Aug. 31, 2023
(86) PCT No.: PCT/US2023/031752

§ 371 Date: Aug. 19, 2025

(30) Foreign Application Priority Data
Mar. 14, 2023 (IN) 202341017155

(51) Int. Cl. G02B 27/01; G02B 27/00

(52) U.S. Cl. CPC G02B 27/0172; G02B 27/0093; G02B 27/0176; G02B 2027/0138; G02B 2027/014; G02B 2027/0161

(57) ABSTRACT

Disclosed are XR systems and apparatuses including a shared ocular region image sensor. An XR system includes a housing configured to interface with a face of a user; at least one display configured to output an image, wherein the at least one display is disposed at a far end of the housing with respect to the face; at least one optical assembly fastened to the at least one display; at least one lens fastened to the at least one optical assembly and configured to focus the image for a corresponding eye; at least one ocular sensor attached to a near surface of the at least one lens and configured to obtain images to track eye movement and a facial characteristic of the user; and an illumination source configured to illuminate a region corresponding to the eye and a region corresponding to the facial characteristic.

### FIELD

The present disclosure generally relates to extended reality (XR) applications. In some examples, aspects of the present disclosure are related to providing an XR headset with a shared ocular region sensor for detecting multiple ocular regions.

### BACKGROUND

Extended reality technologies can be used to present virtual content to users, and/or can combine real environments from the physical world and virtual environments to provide users with extended reality (XR) experiences. The term XR can encompass virtual reality (VR), augmented reality (AR), mixed reality, and the like. Extended reality systems can allow users to experience XR environments by overlaying virtual content onto images of a real-world environment, which can be viewed by a user through an XR device (e.g., a head-mounted display, extended reality glasses, or other devices). An XR device is a device that displays an environment to a user, for example through a head-mounted display (HMD) or other device. The environment is at least partially different from the real-world environment in which the user is in. The user can generally change their view of the environment interactively, for example by tilting or moving the HMD or other device.

In some cases, an XR device can include a “see-through” display that allows the user to see their real-world environment based on light from the real-world environment passing through the display. In some cases, an XR device can include a “pass-through” display that allows the user to see their real-world environment, or a virtual environment based on their real-world environment, based on a view of the environment being captured by one or more cameras and displayed on the display. “See-through” or “pass-through” XR devices can be worn by users while the users are engaged in activities in their real-world environment.

While the goal of many XR devices is to create realistic, interactive, and fully immersive XR environments, XR devices should also ensure that virtual content does not create potentially dangerous situations for users, or otherwise prevent users from properly interacting with the real-world environment. Improved XR devices are needed to dynamically adapt virtual content based on features of the real-world environment.

### SUMMARY

In some examples, systems and techniques are described for detecting fatigue in extended reality (XR) applications. The systems and techniques can improve engagement and safety of different types of XR applications. According to at least one example, an XR apparatus includes: a housing configured to interface with a face of a user, at least one display configured to output an image, wherein the at least one display is disposed at a far end of the housing with respect to the face; at least one optical assembly fastened to the at least one display; at least one lens fastened to the at least one optical assembly and configured to focus the image for at least one eye; at least one ocular sensor attached to a near surface of the at least one lens and configured to obtain images to track eye movement of the at least one eye and a facial characteristic of the user, and an illumination source configured to illuminate a region corresponding to the at least one eye and a region corresponding to the facial characteristic. For example, the XR apparatus is configured to capture an image of the at least one eye and the facial characteristic of the user while the XR apparatus is attached to the user's head.

In another illustrative example, a method includes: emitting light toward an eye and a region corresponding to a facial characteristic using an illumination source; obtaining an image of the eye and the region corresponding to the facial characteristic using at least one ocular sensor; obtaining eye movement information from the image; and obtaining facial characteristic information from the image.

In another illustrative example, an XR apparatus for tracking eye movement and facial expressions is provided that includes: at least one memory (e.g., a memory configured to store data, such as virtual content data, one or more images, etc.), an illumination source configured to emit light toward an eye and a region corresponding to a facial characteristic; at least one ocular sensor configured to obtain an image of the eye and the region corresponding to the facial characteristic; and at least one processor coupled to the at least one memory and the illumination source, the at least one processor configured to: obtain eye movement information from the image; and obtain facial characteristic information from the image.

In another illustrative example, a non-transitory computer-readable medium having stored thereon instructions that, when executed by at least one processor, cause the at least one processor to: emit light toward an eye and a region corresponding to a facial characteristic using an illumination source; obtain an image of the eye and the region corresponding to the facial characteristic using at least one ocular sensor; obtain eye movement information from the image; and obtain facial characteristic information from the image.

In another illustrative example, an XR apparatus for tracking eye movement and facial expressions is provided that includes: means for emitting light toward an eye and a region corresponding to a facial characteristic using an illumination source; means for obtaining an image of the eye and the region corresponding to the facial characteristic using at least one ocular sensor; means for obtaining eye movement information from the image; and means for obtaining facial characteristic information from the image.

In some aspects, one or more of the apparatuses described herein is, is part of, and/or includes a mobile device (e.g., a mobile telephone and/or mobile handset and/or so-called “smartphone” or other mobile device), an XR device (e.g., a virtual reality (VR) device, an augmented reality (AR) device, or a mixed reality (MR) device), a head-mounted device (HMD) device, a vehicle or a computing system, device, or component of a vehicle, a wearable device (e.g., a network-connected watch or other wearable device), a wireless communication device, a camera, a personal computer, a laptop computer, a server computer, another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensors).

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating a simplified cross-sectional view of a lens assembly of an extended reality system, in accordance with certain aspects described herein;

FIG. 2 is a block diagram illustrating an architecture of an image capture and processing system, in accordance with certain aspects described herein;

FIG. 3 is a conceptual diagram of an XR device that includes a plurality of image sensors for detecting eye movement (e.g., gaze) and eyebrow movement;

FIG. 4A is an image of an eye of a user captured by an image sensor in an XR device;

FIG. 4B is an image of an eye captured by an eyebrow tracking image sensor in an XR device;

FIG. 5 is a block diagram illustrating an architecture of an XR device with at least one shared ocular region sensor, in accordance with certain aspects described herein;

FIG. 6 is a block diagram illustrating a cross-sectional view of a lens assembly of an XR device with at least one shared ocular region sensor, in accordance with certain aspects described herein;

FIG. 7 is a perspective view of an XR device with at least one shared ocular region sensor, in accordance with certain aspects described herein;

FIG. 8 is a conceptual diagram illustrating a position of at least one shared ocular region sensor that is integral to an XR device, in accordance with certain aspects described herein;

FIG. 9 is an image of a user and illustrates facial expressions that can be detected by an XR device with a shared ocular region sensor, in accordance with certain aspects described herein;

FIG. 10 is a flow diagram illustrating an example of a method for capturing an image in an XR apparatus, in accordance with certain aspects described herein; and

FIG. 11 is a diagram illustrating an example of a system for implementing certain aspects described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras can be configured with a variety of image capture and image processing settings. The different settings result in images with different appearances. Some camera settings are determined and applied before or during capture of one or more image frames, such as International Organization of Standardization (ISO), exposure time, aperture size, f/stop, shutter speed, focus, and gain. For example, settings or parameters can be applied to an image sensor for capturing the one or more image frames. Other camera settings can configure post-processing of one or more image frames, such as alterations to contrast, brightness, saturation, sharpness, levels, curves, or colors. For example, settings or parameters can be applied to a processor (e.g., an image signal processor or ISP) for processing the one or more image frames captured by the image sensor.

Extended reality (XR) systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. XR systems or devices can facilitate interaction with different types of XR environments (e.g., a user can use an XR system or device to interact with an XR environment). XR devices can include virtual reality (VR) systems facilitating interactions with VR environments, augmented reality (AR) systems facilitating interactions with AR environments, mixed reality (MR) systems facilitating interactions with MR environments, and/or other XR devices. Examples of XR systems or devices include head-mounted displays (HMDs), smart glasses, among others. In some cases, an XR device can track parts of the user (e.g., a hand and/or fingertips of a user) to allow the user to interact with items of virtual content.

In some cases, an XR device can include an optical “see-through” or “pass-through” display (e.g., see-through or pass-through AR HMD or AR glasses), allowing the XR device to display XR content (e.g., AR content) directly onto a real-world view without displaying video content. For example, a user may view physical objects through a display (e.g., glasses or lenses), and the AR system can display AR content onto the display to provide the user with an enhanced visual perception of one or more real-world objects. In one example, a display of an optical see-through AR system can include a lens or glass in front of each eye (or a single lens or glass over both eyes). The see-through display can allow the user to see a real-world or physical object directly, and can display (e.g., projected or otherwise displayed) an enhanced image of that object or additional AR content to augment the user's visual perception of the real world.

An XR device can include one or more user-facing sensors that face the user, such as user-facing image sensors (or cameras) that face the user. For instance, the user-facing sensors can face the user's face, eyes, one or more other portions of the user's body, and/or a combination thereof. In some cases, an XR device may track an ocular region of a face of a user, such as the eyes of the user to determine gaze and a region surrounding the eyes (e.g., the eyebrows) of the user to determine facial expressions. For example, in a social XR environment, non-verbal cues can be important in understanding context of the communication. A social XR environment may be any network communication medium that presents audio and virtual content (e.g., virtual objects, virtual representations, or avatars of users) and that enables social interaction through verbal and non-verbal communication. An avatar (also referred to as a virtual representation) of a user is a digital representation of the user within an XR environment. Non-verbal communication can take many forms, such as facial expressions, hand gestures, and so forth. In some cases, non-verbal communication can be eye-based communications, such as rolling of the eye, biasing various facial muscles (e.g., orbicularis oculi, temporalis, frontalis, corrugator supercilii, etc.) to move the eyebrows, blinking, and so forth. Non-verbal communications provide humans with context to understand the communication, and failure to include sufficiently accurate non-verbal communication can often result in miscommunication within the social XR environment.

In some existing XR devices, gaze detection, and movement of the eye(s) may be accomplished by a narrow field of view (FOV) image sensor that is oriented towards the pupil of the eye. Existing XR devices may require an extra image sensor for each eye. The additional images provided by the extra image sensor increase the processing requirement, and increase complexity because the gaze detection (e.g., eye motion tracking) must be synthesized with the motion detection of the eyebrow.

The present disclosure describes an XR apparatus (e.g., a headset, such as a head-mounted display (HMD)) that includes at least one shared ocular image sensor (also referred to herein as an ocular sensor) configured to detect eye movement and movement of region(s) around the eye (e.g., eyebrow movement) based on a configuration and position of the at least one shared ocular image sensor in the XR apparatus. In some aspects, the XR apparatus can include a housing configured to interface with a face of a user (e.g., be worn by the user) and at least one display configured to output an image. For instance, the at least one display can be disposed at a far end of the housing with respect to the face. In some cases, the XR apparatus can also include at least one optical assembly fastened to the at least one display, and at least one lens fastened to the at least one optical assembly and configured to focus the image for a corresponding eye. In some aspects, a shared ocular sensor of the XR apparatus is attached to a near surface of the at least one lens. Each shared ocular sensor is configured to obtain images to track eye movement and movement of the region(s) around the eye (e.g., to obtain images of an eyebrow to track movement of the eyebrow). In some cases, the XR apparatus can include an illumination source configured to illuminate the corresponding eye and the surrounding region(s) (e.g., a respective illumination source for each eyebrow region).

In some aspects, the at least one ocular image sensor is configured to capture light in an infrared spectrum (e.g., near-infrared (NIR) light), and the illumination source is configured to emit light in the infrared spectrum. For instance, in some cases, light emitted in a visible spectrum can interfere with an output from the display of the XR apparatus. Use of light in the infrared spectrum can prevent such interference, and can also be safer than visible light when exposed to eyes of a user. In some aspects, the at least one ocular sensor is positioned in a lower eyelid region and proximate to a lateral canthus of the user's eye. The at least one ocular sensor is configured to have a FOV that can capture images of the eye region and the surrounding region(s) (e.g., an eyebrow region(s) of the eye(s)) with sufficient detail. In some cases, an exposure time of the at least one ocular sensor (e.g., image sensor) may be set to enable capture of the eye region and the eyebrow region with sufficient luminance for processing and detection motion of both the eye and the surrounding region(s) (e.g., the eyebrow region(s)). The motion of the eye and the surrounding region(s) (e.g., the eyebrow region(s)) can be mapped to an XR environment to create an immersive experience.

Additional details and aspects of the present disclosure are described in more detail below with respect to the figures.

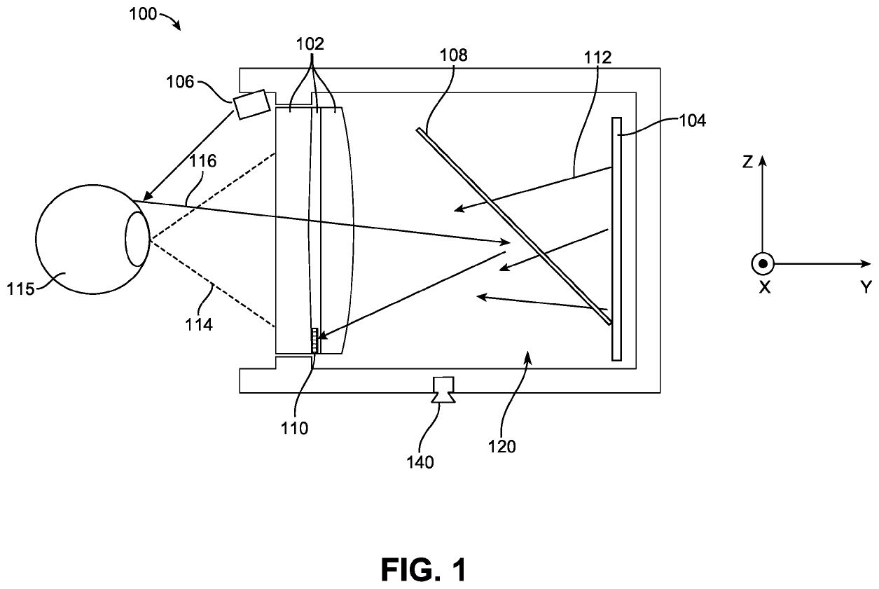

Various aspects of the techniques described herein will be discussed below with respect to the figures. FIG. 1 is a diagram illustrating a simplified cross-sectional view of lens assembly 100 (e.g., of an HMD). In the illustrated example of FIG. 1, the lens assembly 100 includes a lens system 102, a display 104, an illumination source 106, a light directing component 108, and an image sensor 110.

As illustrated, light from the display 104 can pass through the light directing component 108 and be focused by the lens system 102 on the user's eye 115. The lens system 102 can include a plurality of lenses that are stacked and configured to focus light towards a user's eye. In some cases, an image sensor 110 may be embedded into a layer of the lens system 102 and is unperceivable to the human eye based on its size and location. In some implementations, the light directing component 108 can be configured to allow visible light from the display 104 to pass through. In the illustrated example of FIG. 1, the light directing component 108 is positioned within a cavity 120 of the lens assembly 100 between the lens system 102 and the display 104. As illustrated in FIG. 1, the visible light 112 can be focused at the position of the user's eye 115 as illustrated by lines 114. In some cases, the light directing component 108 can be configured to reflect other wavelengths of light, such as infrared (IR) light. In some examples, the light directing component 108 can be implemented using a reflective coating. In some implementations, the light directing component 108 can include a dielectric material that passes visible light and reflects IR light. In some examples, the light directing component 108 can be coated with a transparent conductor. In one illustrative example, an indium-tin-oxide (ITO) material that is transparent to visible light and reflects IR light can be used to coat the light directing component 108. The illumination source 106 can be an IR illumination source (e.g., an IR light emitting diode (LED)) that illuminates the user's eye 115. When the IR light reaches the user's eye 115, a scattered and/or reflected portion of the light, such as the example ray 116 can reach the light directing component 108 and reflect towards the image sensor 110.

The image sensor 110 can be an IR image sensor that can detect the scattered and/or reflected light from the eye to form one or more images. In some cases, an XR device can obtain image data from the image sensor 110 and track the user's eye position and/or gaze direction based on the obtained data. The light directing component 108 may reflect IR light that is reflected by the user's eye 115 and direct the IR light to the image sensor 110, which is juxtaposed between different layers of the lens system 102.

In some cases, the position of a user's eyes relative to the lens assembly 100 can vary. For example, each individual user may have different eyes size, face shape, face symmetry, eye separation, facial feature alignment, and/or a combination thereof. In some implementations, an eye tracking system can be configured to perform eye tracking over a specified range of eye positions and/or rotations using the image data collected, for example, from the image sensor 110. In some cases, if the user's eye 115 moves outside of the specific range, the XR device may be unable to perform eye tracking until the user's eye 115 returns to a position and/or rotation within the specific range. For example, if the user's eye 115, shown in FIG. 1, rotates to look down (e.g., toward the negative z-axis direction), the image of the user's eye 115 may be obstructed by eyelashes and/or by the curvature of the user's eye 115. In some cases, the range of eye tracking may be limited by the desire to keep the lens assembly 100 of an XR device compact.

In other aspects, the lens assembly 100 may also include a vertically oriented image sensor 140. In the illustrated example, the image sensor 140 is configured to point downwards to capture images related to respiratory functions of the user. For example, the lens assembly 100 may measure a respiratory rate (e.g., the breathing rate of the user) based on the image sensor 140 being oriented towards the nose of the user, the mouth of the user, and/or the chest of the user. Other types of sensors can be implemented to detect respiratory rate, such as radio frequency (RF) sensing sensors. In some aspects, high frequency (e.g., 60 GHz) RF may be used to measure distance based on phase differences.

While examples are described herein for eye tracking in XR devices, the eye tracking systems and techniques described herein can be used for eye tracking with other types of devices and with other geometries. Of note, the illustration in FIG. 1 is not to scale and is provided only for the purposes of illustration. In addition, more or fewer components can be included in the lens assembly 100 of FIG. 1 without departing from the scope of the present disclosure.

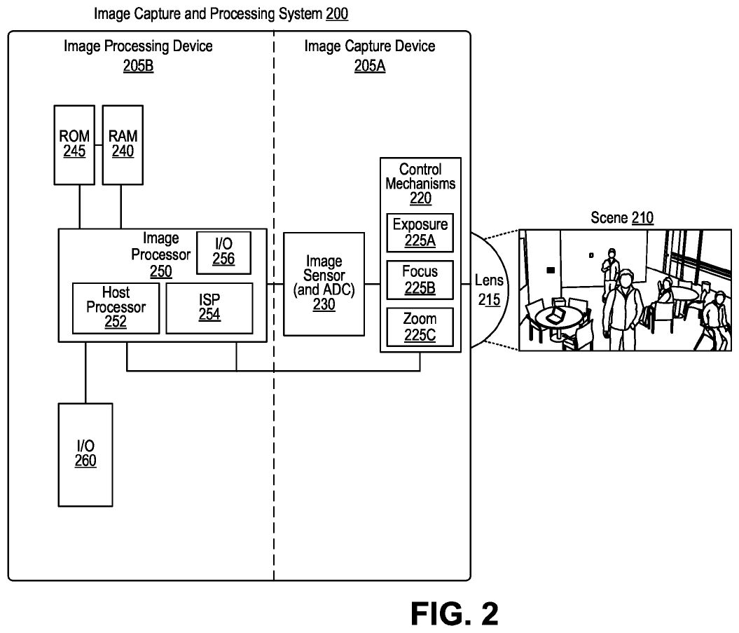

FIG. 2 is a block diagram illustrating an architecture of an image capture and processing system 200. The image capture and processing system 200 includes various components that are used to capture and process images of scenes (e.g., an image of a scene 210). The image capture and processing system 200 can capture standalone images (or photographs) and/or can capture videos that include multiple images (or video frames) in a particular sequence. In some cases, the lens 215 and image sensor 230 can be associated with an optical axis. In one illustrative example, the photosensitive area of the image sensor 230 (e.g., the photodiodes) and the lens 215 can both be centered on the optical axis. A lens 215 of the image capture and processing system 200 faces a scene 210 and receives light from the scene 210. The lens 215 bends incoming light from the scene 210 toward the image sensor 230. The light received by the lens 215 passes through an aperture. In some cases, the aperture (e.g., the aperture size) is controlled by one or more control mechanisms 220 and is received by an image sensor 230. In some cases, the aperture can have a fixed size.

The one or more control mechanisms 220 may control exposure, focus, and/or zoom based on information from the image sensor 230 and/or based on information from the image processor 250. The one or more control mechanisms 220 may include multiple mechanisms and components; for instance, the control mechanisms 220 may include one or more exposure control mechanisms 225A, one or more focus control mechanisms 225B, and/or one or more zoom control mechanisms 225C. The one or more control mechanisms 220 may also include additional control mechanisms besides those that are illustrated, such as control mechanisms for controlling analog gain, flash, HDR, depth of field, and/or other image capture properties.

The focus control mechanism 225B of the control mechanisms 220 can obtain a focus setting. In some examples, focus control mechanism 225B stores the focus setting in a memory register. Based on the focus setting, the focus control mechanism 225B can adjust the position of the lens 215 relative to the position of the image sensor 230. For example, based on the focus setting, the focus control mechanism 225B can move the lens 215 closer to the image sensor 230 or farther from the image sensor 230 by actuating a motor or servo (or other lens mechanism), thereby adjusting focus. In some cases, additional lenses may be included in the image capture and processing system 200, such as one or more microlenses over each photodiode of the image sensor 230, which each bend the light received from the lens 215 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 220, the image sensor 230, and/or the image processor 250. The focus setting may be referred to as an image capture setting and/or an image processing setting. In some cases, the lens 215 can be fixed relative to the image sensor 230 and the focus control mechanism 225B can be omitted without departing from the scope of the present disclosure.

The exposure control mechanism 225A of the control mechanisms 220 can obtain an exposure setting. In some cases, the exposure control mechanism 225A stores the exposure setting in a memory register. Based on this exposure setting, the exposure control mechanism 225A can control a size of the aperture (e.g., aperture size or f/stop), a duration of time for which the aperture is open (e.g., exposure time or shutter speed), a duration of time for which the image sensor 230 collects light (e.g., exposure time or electronic shutter speed), a sensitivity of the image sensor 230 (e.g., ISO speed or film speed), an analog gain applied by the image sensor 230, or any combination thereof. The exposure setting may be referred to as an image capture setting and/or an image processing setting.

The zoom control mechanism 225C of the control mechanisms 220 can obtain a zoom setting. In some examples, the zoom control mechanism 225C stores the zoom setting in a memory register. Based on the zoom setting, the zoom control mechanism 225C can control a focal length of an assembly of lens elements (lens assembly) that includes the lens 215 and one or more additional lenses. For example, the zoom control mechanism 225C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 215 in some cases) that receives the light from the scene 210 first, with the light then passing through an afocal zoom system between the focusing lens (e.g., lens 215) and the image sensor 230 before the light reaches the image sensor 230. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 225C moves one or more of the lenses in the afocal zoom system, such as the negative lens and one or both of the positive lenses. In some cases, zoom control mechanism 225C can control the zoom by capturing an image from an image sensor of a plurality of image sensors (e.g., including image sensor 230) with a zoom corresponding to the zoom setting. For example, image capture and processing system 200 can include a wide-angle image sensor with a relatively low zoom and a telephoto image sensor with a greater zoom. In some cases, based on the selected zoom setting, the zoom control mechanism 225° C. can capture images from a corresponding sensor.

The image sensor 230 includes one or more arrays of photodiodes or other photosensitive elements. Each photodiode measures an amount of light that eventually corresponds to a particular pixel in the image produced by the image sensor 230. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Other types of color filters may use yellow, magenta, and/or cyan (also referred to as “emerald”) color filters instead of or in addition to red, blue, and/or green color filters. In some cases, photodiodes may be configured to measure IR light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 230) may lack filters (e.g., color, IR, or any other part of the light spectrum) altogether and may instead use different photodiodes throughout the pixel array (in some cases, vertically stacked). The different photodiodes throughout the pixel array can have different spectral sensitivity curves, therefore responding to different wavelengths of light. Monochrome image sensors may also lack filters and, therefore, lack color depth.

In some cases, the image sensor 230 may alternately or additionally include opaque and/or reflective masks that block light from reaching certain photodiodes, or portions of certain photodiodes, at certain times and/or from certain angles. In some cases, opaque and/or reflective masks may be used for PDAF. In some cases, the opaque and/or reflective masks may be used to block portions of the electromagnetic spectrum from reaching the photodiodes of the image sensor (e.g., an IR cut filter, an ultraviolet (UV) cut filter, a band-pass filter, a low-pass filter, a high-pass filter, or the like). The image sensor 230 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 220 may be included instead or additionally in the image sensor 230. The image sensor 230 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

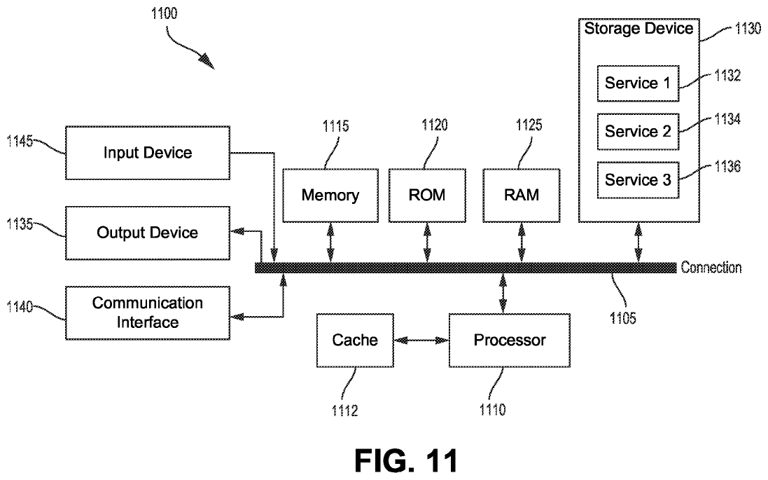

The image processor 250 may include one or more processors, such as one or more image signal processors (ISPs) (including ISP 254), one or more host processors (including host processor 252), and/or one or more of any other type of processor, such as processor 1010 discussed with respect to the computing system 1000 of FIG. 11. The host processor 252 can be a digital signal processor (DSP) and/or other type of processor. In some implementations, the image processor 250 is a single integrated circuit or chip (e.g., referred to as a system-on-chip or SoC) that includes the host processor 252 and the ISP 254. In some cases, the chip can also include one or more input/output ports (e.g., input/output (I/O) ports 256), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 256 can include any suitable input/output ports or interface according to one or more protocols or specifications, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface), an Advanced High-performance Bus (AHB) bus, any combination thereof, and/or other input/output port. In one illustrative example, the host processor 252 can communicate with the image sensor 230 using an I2C port, and the ISP 254 can communicate with the image sensor 230 using an MIPI port.

The image processor 250 may perform a number of tasks, such as de-mosaicing, color space conversion, image frame downsampling, pixel interpolation, automatic exposure (AE) control, automatic gain control (AGC), CDAF, PDAF, automatic white balance (AWB), merging of image frames to form an HDR image, image recognition, object recognition, feature recognition, receipt of inputs, managing outputs, managing memory, or some combination thereof. The image processor 250 may store image frames and/or processed images in random access memory (RAM) 240, read-only memory (ROM) 245, a cache, a memory unit, another storage device, or some combination thereof.

Various input/output (I/O) devices 260 may be connected to the image processor 250. The I/O devices 260 can include a display screen, a keyboard, a keypad, a touchscreen, a trackpad, a touch-sensitive surface, a printer, any other output device, any other input devices, or some combination thereof. In some cases, a caption may be input into the image processing device 205B through a physical keyboard or keypad of the I/O devices 260, or through a virtual keyboard or keypad of a touchscreen of the I/O devices 260. The I/O devices 260 may include one or more ports, jacks, or other connectors that enable a wired connection between the image capture and processing system 200 and one or more peripheral devices, over which the image capture and processing system 200 may receive data from the one or more peripheral devices and/or transmit data to the one or more peripheral devices. The I/O 260 may include one or more wireless transceivers that enable a wireless connection between the image capture and processing system 200 and one or more peripheral devices, over which the image capture and processing system 200 may receive data from the one or more peripheral devices and/or transmit data to the one or more peripheral devices. The peripheral devices may include any of the previously-discussed types of I/O devices 260 and may themselves be considered I/O devices 260 once they are coupled to the ports, jacks, wireless transceivers, or other wired and/or wireless connectors.

In some cases, the image capture and processing system 200 may be a single device. In some cases, the image capture and processing system 200 may be two or more separate devices, including an image capture device 205A (e.g., a camera) and an image processing device 205B (e.g., a computing device coupled to the camera). In some implementations, the image capture device 205A and the image processing device 205B may be coupled together, for example via one or more wires, cables, or other electrical connectors, and/or wirelessly via one or more wireless transceivers. In some implementations, the image capture device 205A and the image processing device 205B may be disconnected from one another.

As shown in FIG. 2, a vertical dashed line divides the image capture and processing system 200 of FIG. 2 into two portions that represent the image capture device 205A and the image processing device 205B, respectively. The image capture device 205A includes the lens 215, control mechanisms 220, and the image sensor 230. The image processing device 205B includes the image processor 250 (including the ISP 254 and the host processor 252), the RAM 240, the ROM 245, and the I/O 260. In some cases, certain components illustrated in the image processing device 205B, such as the ISP 254 and/or the host processor 252, may be included in the image capture device 205A.

The image capture and processing system 200 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 200 can include one or more wireless transceivers for wireless communications, such as cellular network communications, 802.11 wi-fi communications, wireless local area network (WLAN) communications, or some combination thereof. In some implementations, the image capture device 205A and the image processing device 205B can be different devices. For instance, the image capture device 205A can include a camera device, and the image processing device 205B can include a computing device, such as a mobile handset, a desktop computer, or other computing device.

While the image capture and processing system 200 is shown to include certain components, one of ordinary skill will appreciate that the image capture and processing system 200 can include more components than those shown in FIG. 2. The components of the image capture and processing system 200 can include software, hardware, or one or more combinations of software and hardware. For example, in some implementations, the components of the image capture and processing system 200 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 200.

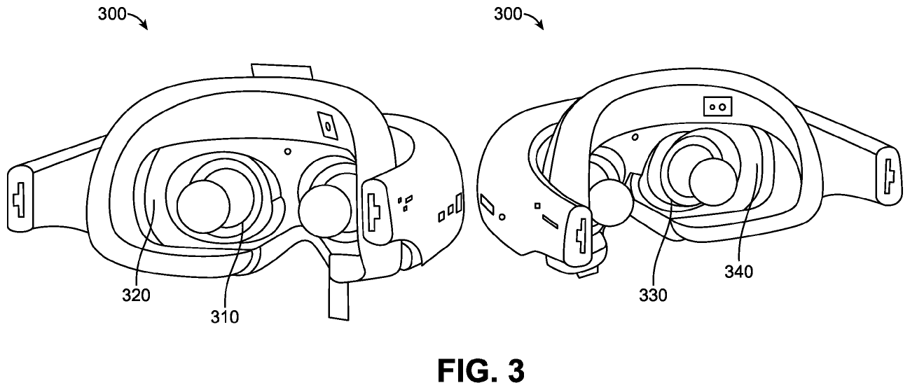

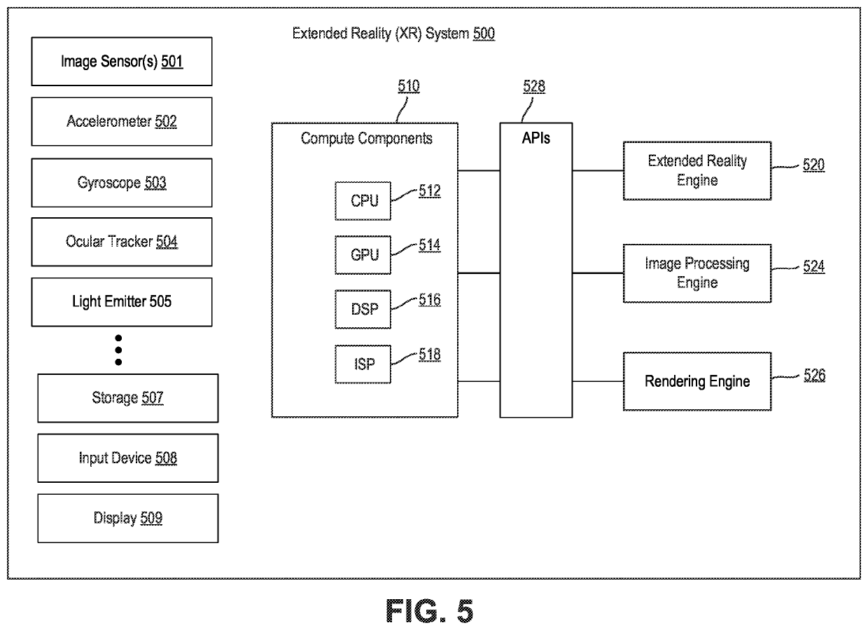

In some examples, the XR device 300 of FIG. 3 (described below) and the XR device 500 of FIG. 5 (described below) can include the image capture and processing system 200, the image capture device 205A, the image processing device 205B, or a combination thereof.

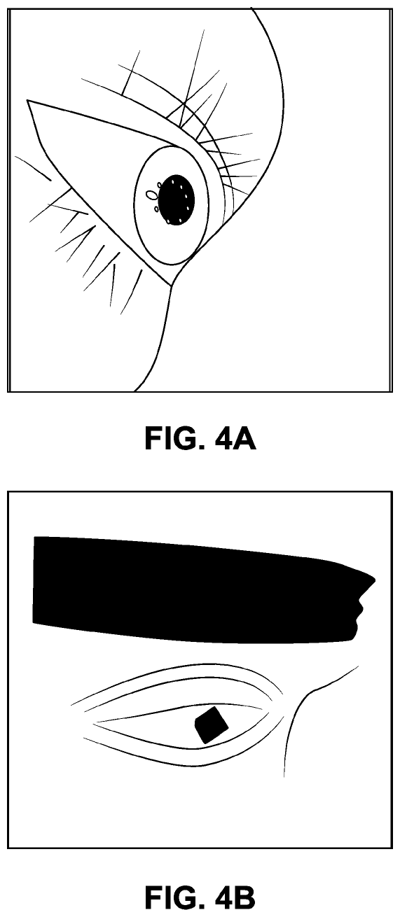

FIG. 3 is a conceptual diagram showing two views of an XR device 300 that includes a plurality of image sensors for detecting eye movement (e.g., gaze) and eyebrow movement. In some aspects, the eye movement can be used for foveated rendering. Foveated rendering is technique that renders a region of interest (ROI) in a scene at higher quality than a background region. In some cases, the XR device 300 can use a left eye image sensor 310 and a right eye image sensor 330 to detect a focal point of the user's gaze. The XR device 300 or another device configured to render the image for the XR device 300 (e.g., a cloud device, an external computing system, etc.) may render the ROI at a higher quality than the background region. For example, the resolution of the background region may be rendered at a lower resolution and then scaled to match the higher resolution of the ROI. In some aspects, the left eye image sensor 310 and the right eye image sensor 330 may have a narrow FOV and are configured to capture images of the user's pupil. An example of an image captured by the left eye image sensor 310 or the right eye image sensor 330 is shown in FIG. 4A.

In some aspects, the XR device includes a left eyebrow image sensor 320 and a right eyebrow image sensor 340. The left eyebrow image sensor 320 and the right eyebrow image sensor 340 are configured to capture images of the corresponding eyebrow region and separately process the eyebrow images from the eyes. An example of an image captured by the left eyebrow image sensor 320 or the right eyebrow image sensor 340 is shown in FIG. 4B.

FIG. 4A is an image of an eye of a user captured by an image sensor in an XR device. In some aspects, light emitters of the XR device are configured to emit light and provide luminance in the non-visible spectrum to the eye. For example, the pupil of the eye in FIG. 4A can reflect a portion of light from several light emitters of the XR device. As illustrated in FIG. 4A, the light emitters provide light to the orbicularis oculi region of the eye, but do not provide sufficient lighting to the eyebrow region.

FIG. 4B is an image of an eye captured by an eyebrow tracking image sensor in an XR device. In some aspects, the eyebrow tracking image sensor may be configured to capture the eyebrow region although the eyebrow tracking image sensor is unable to sufficiently detect detail associated with a pupil of the user's eye. In some aspects, the eyebrow tracking image sensor requires separate processing of the user's eye and eyebrow region, which increases hardware requirements by virtue of additional sensors, and also requires separate lighting.

The processing of eye and eyebrow images is challenging because information must be synthesized in correct order, and different information provided by the separate processing can lead to an incorrect analysis. Aspects of the disclosure relate to improving the processing of the eye and eyebrows by consolidating the image capture operation of the eye image sensor and the eyebrow image sensor into a single shared image sensor with a sufficient FOV and lighting.

FIG. 5 is a diagram illustrating an architecture of an example XR device 500 (e.g., XR system), in accordance with some aspects of the disclosure. The XR device 500 can run (or execute) XR applications and implement XR operations. In some examples, the XR device 500 can perform tracking and localization, mapping of an environment in the physical world (e.g., a scene), and/or positioning and rendering of virtual content on a display 509 (e.g., a screen, visible plane/region, and/or other display) as part of an XR experience. For example, the XR device 500 can generate a map (e.g., a three-dimensional (3D) map) of an environment in the physical world, track a pose (e.g., location and position) of the XR device 500 relative to the environment (e.g., relative to the 3D map of the environment), position and/or anchor virtual content in a specific location(s) on the map of the environment, and render the virtual content on the display 509 such that the virtual content appears to be at a location in the environment corresponding to the specific location on the map of the scene where the virtual content is positioned and/or anchored. The display 509 can include a glass, a screen, a lens, a projector, and/or another display mechanism that allows a user to see the real-world environment and also allows XR content to be overlaid, overlapped, blended with, or otherwise displayed thereon.

In this illustrative example, the XR device 500 includes one or more image sensors 501, an accelerometer 502, a gyroscope 503, an ocular tracker 504, one or more light emitters 505, storage 507, compute components 510, an XR engine 520, an image processing engine 524, and a rendering engine 526. In the example shown in FIG. 5, the engines 520-526 may access hardware components, such as components 501-518, or another engine 520-526 via one or more application programming interfaces (APIs) 528. Generally, APIs 528 are a set of functions, services, and/or interfaces, which act as a connection between computer components, computers, or computer programs. The APIs 528 may provide a set of API calls that may be accessed by applications that allow information to be exchanged, hardware to be accessed, or other actions to be performed.

It should be noted that the components 501-528 shown in FIG. 5 are non-limiting examples provided for illustrative and explanation purposes, and other examples can include more, less, or different components than those shown in FIG. 5. For example, in some cases, the XR device 500 can include one or more other sensors (e.g., one or more inertial measurement units (IMUs), light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, and/or one or more other software and/or hardware components that are not shown in FIG. 5. While various components of the XR device 500, such as the accelerometer 502, may be referenced in the singular form herein, it should be understood that the XR device 500 may include multiple of any component discussed herein (e.g., multiple accelerometers 502).

The XR device 500 includes or is in communication with (wired or wirelessly) an input device 508. The input device 508 can include any suitable input device, such as a touchscreen, a pen or other pointer device, a keyboard, a mouse button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, one or more image sensors 501 can capture images that can be processed for interpreting gesture commands.

In some implementations, the one or more image sensors 501, the accelerometer 502, the gyroscope 503, storage 507, compute components 510, XR engine 520, image processing engine 524, and rendering engine 526 can be part of the same computing device. For example, in some cases, the one or more image sensors 501, the accelerometer 502, the gyroscope 503, storage 507, compute components 510, APIs 528, XR engine 520, image processing engine 524, and rendering engine 526 can be integrated into an HMD, extended reality glasses, smartphone, laptop, tablet computer, gaming system, and/or any other computing device. However, in some implementations, the one or more image sensors 501, the accelerometer 502, the gyroscope 503, ocular tracker 504, light emitter 505, storage 507, compute components 510, APIs 528, XR engine 520, image processing engine 524, and rendering engine 526 can be part of two or more separate computing devices. For example, in some cases, some of the components 501-526 can be part of or implemented by, one computing device, and the remaining components can be part of or implemented by, one or more other computing devices.

The storage 507 can be any storage device(s) for storing data. Moreover, the storage 507 can store data from any of the components of the XR device 500. For example, the storage 507 can store data from the one or more image sensors 501 (e.g., image or video data), data from the ocular tracker 504 (e.g., eye tracking data), data from the accelerometer 502 (e.g., measurements), data from the gyroscope 503 (e.g., measurements), data from the compute components 510 (e.g., processing parameters, preferences, virtual content, rendering content, scene maps, tracking and localization data, object detection data, privacy data, XR application data, face recognition data, occlusion data, etc.), data from the XR engine 520, data from the image processing engine 524, and/or data from the rendering engine 526 (e.g., output frames). In some examples, the storage 507 can include a buffer for storing frames for processing by the compute components 510.

The one or more compute components 510 can include a CPU 512, a GPU 514, a DSP 516, an ISP 518, and/or other processor (e.g., a neural processing unit (NPU) implementing one or more trained neural networks). The compute components 510 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 510 can implement (e.g., control, operate, etc.) the XR engine 520, the image processing engine 524, and the rendering engine 526. In other examples, the compute components 510 can also implement one or more other processing engines.

The one or more image sensors 501 can include any image and/or video sensors or capturing devices. The one or more image sensors 501 can include one or more user-facing image sensors. In some cases, user-facing image sensors can be included in the one or more image sensors 501. In some examples, user-facing image sensors can be used for face tracking, eye tracking, body tracking, and/or any combination thereof. The one or more image sensors 501 can include one or more environment facing sensors. In some cases, the environment facing sensors can face in a similar direction as the gaze direction of a user. In some examples, the one or more image sensors 501 can be part of a multiple-camera assembly, such as a dual-camera assembly. The one or more image sensors 501 can capture image and/or video content (e.g., raw image and/or video data), which can then be processed by the compute components 510, the XR engine 520, the image processing engine 524, and/or the rendering engine 526 as described herein. In some examples, the image sensors 501 may include an image capture and processing system 200, an image capture device 205A, an image processing device 205B, or a combination thereof.

In some examples, one or more image sensors 501 can capture image data and can generate images (also referred to as frames) based on the image data and/or can provide the image data or frames to the XR engine 520, the image processing engine 524, and/or the rendering engine 526 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, one or more image sensors 501 (and/or other cameras of the XR device 500) can be configured to also capture depth information. For example, in some implementations, one or more image sensors 501 (and/or other camera) can include an RGB-depth (RGB-D) camera. In some cases, the XR device 500 can include one or more depth sensors (not shown) that are separate from the one or more image sensors 501 (and/or other camera) and that can capture depth information. For instance, such a depth sensor can obtain depth information independently from the one or more image sensors 501. In some examples, a depth sensor can be physically installed in the same general location as the one or more image sensors 501 but may operate at a different frequency or frame rate from the one or more image sensors 501. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors, such as a combination of an infra-red structured light projector and an infra-red camera registered to a camera (e.g., an RGB camera).

The XR device 500 can also include other sensors integral to one or more sensors. The one or more sensors can include one or more accelerometers (e.g., accelerometer 502), one or more gyroscopes (e.g., gyroscope 503), and/or other sensors. The one or more sensors can provide velocity, orientation, and/or other position-related information to the compute components 510. For example, the accelerometer 502 can detect acceleration by the XR device 500, and can generate acceleration measurements based on the detected acceleration. In some cases, the accelerometer 502 can provide one or more translational vectors (e.g., up/down, left/right, forward/back) that can be used for determining a position or pose of the XR device 500. The gyroscope 503 can detect and measure the orientation and angular velocity of the XR device 500. For example, the gyroscope 503 can be used to measure the pitch, roll, and yaw of the XR device 500. In some cases, the gyroscope 503 can provide one or more rotational vectors (e.g., pitch, yaw, roll). In some examples, the one or more image sensors 501 and/or the XR engine 520 can use measurements obtained by the accelerometer 502 (e.g., one or more translational vectors) and/or the gyroscope 503 (e.g., one or more rotational vectors) to calculate the pose of the XR device 500. The XR device 500 can also include the ocular tracker 504 for tracking movement of the eyes of a user of the XR device 500. The ocular tracker 504 of the XR device 500 may operate in a manner similar to eye tracking as described with respect to FIG. 1.

The output of one or more sensors (e.g., the accelerometer 502, the gyroscope 503, one or more IMUs, and/or other sensors) can be used by the XR engine 520 to determine a pose of the XR device 500 (also referred to as the head pose) and/or the pose of one or more image sensors 501 (or other camera of the XR device 500). In some cases, the pose of the XR device 500 and the pose of one or more image sensors 501 (or other camera) can be the same. The pose of image sensor 501 refers to the position and orientation of the one or more image sensors 501 relative to a frame of reference (e.g., with respect to an object). In some implementations, the camera pose can be determined for 6-Degrees of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees of Freedom (3DoF), which refers to the three angular components (e.g., roll, pitch, and yaw).

In some cases, a device tracker (not shown) can use the measurements from the one or more sensors and image data from one or more image sensors 501 to track a pose (e.g., a 6DoF pose) of the XR device 500. For example, the device tracker can fuse visual data (e.g., using a visual tracking solution) from the image data with inertial data from the measurements to determine a position and motion of the XR device 500 relative to the physical world (e.g., the scene) and a map of the physical world. As described below, in some examples, when tracking the pose of the XR device 500, the device tracker can generate a 3D map of the scene (e.g., the real world) and/or generate updates for a 3D map of the scene. The 3D map updates can include, for example, and without limitation, new or updated features and/or feature or landmark points associated with the scene and/or the 3D map of the scene, localization updates identifying or updating a position of the XR device 500 within the scene and the 3D map of the scene, etc. The 3D map can provide a digital representation of a scene in the real/physical world. In some examples, the 3D map can anchor location-based objects and/or content to real-world coordinates and/or objects. The XR device 500 can use a mapped scene (e.g., a scene in the physical world represented by, and/or associated with, a 3D map) to merge the physical and virtual worlds and/or merge virtual content or objects with the physical environment.

In some aspects, the pose of image sensor 501 and/or the XR device 500 as a whole can be determined and/or tracked by the compute components 510 using a visual tracking solution based on images captured by the one or more image sensors 501 (and/or other camera of the XR device 500). For instance, in some examples, the compute components 510 can perform tracking using computer vision-based tracking, model-based tracking, and/or simultaneous localization and mapping (SLAM) techniques. For instance, the compute components 510 can perform SLAM or can be in communication (wired or wireless) with a SLAM system (not shown). SLAM refers to a class of techniques where a map of an environment (e.g., a map of an environment being modeled by XR device 500) is created while simultaneously tracking the pose of a camera (e.g., image sensor 501) and/or the XR device 500 relative to that map. The map can be referred to as a SLAM map and can be 3D. The SLAM techniques can be performed using color or grayscale image data captured by one or more image sensors 501 (and/or other camera of the XR device 500) and can be used to generate estimates of 6DoF pose measurements of one or more image sensors 501 and/or the XR device 500. Such a SLAM technique configured to perform 6DoF tracking can be referred to as a 6DoF SLAM. In some cases, the output of the one or more sensors (e.g., the accelerometer 502, the gyroscope 503, one or more IMUs, and/or other sensors) can be used to estimate, correct, and/or otherwise adjust the estimated pose.

In some cases, the 6DoF SLAM (e.g., 6DoF tracking) can associate features observed from certain input images from one or more image sensors 501 (and/or other camera) to the SLAM map. For example, 6DoF SLAM can use feature point associations from an input image to determine the pose (position and orientation) of one or more image sensors 501 and/or XR device 500 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of one or more image sensors 501 and/or the XR device 500 can be determined by projecting features from the 3D SLAM map into an image or video frame and updating the camera pose from verified 2D-3D correspondences.

In one illustrative example, the compute components 510 can extract feature points from certain input images (e.g., every input image, a subset of the input images, etc.) or from each key frame. A feature point (also referred to as a registration point) as used herein is a distinctive or identifiable part of an image, such as a part of a hand, or an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR device 500 can also track the hand and/or fingers of the user to allow the user to interact with and/or control virtual content in a virtual environment. For example, the XR device 500 can track a pose and/or movement of the hand and/or fingertips of the user to identify or translate user interactions with the virtual environment. The user interactions can include, for example, and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

As noted above, in some cases, the one or more sensors can include at least one IMU. An IMU is an electronic device that measures the specific force, angular rate, and/or the orientation of the XR device 500, using a combination of one or more accelerometers, one or more gyroscopes, and/or one or more magnetometers. In some examples, the one or more sensors can output measured information associated with the capture of an image captured by one or more image sensors 501 (and/or other camera of the XR device 500) and/or depth information obtained using one or more depth sensors of the XR device 500.

The image sensors 501 of XR device 500 can include an ocular tracker 504 that is configured to track gaze, eye movement, and eyebrow movement, such as the example discussed in FIG. 1. In some examples, the ocular tracker 504 can obtain images of one or both of a user's eyes from user-facing image sensors of the one or more image sensors 501. For example, the image sensors 501 may be configured to detect non-visible or IR light. The light emitter 505 may be configured to emit light within the XR device 500 such that the image sensor 501 can obtain an image of the eye. In some aspects, the light emitter 505 may increase a brightness to a maximum amount without affecting the user receiving light in the visible spectrum. In other aspects, the image sensor 501 can increase an exposure time. Increasing the exposure time provides a better image, but increases opportunity for the obtained image to be blurry based on motioning within the exposure time As previously noted, in other examples, the XR device 500 can also include other sensors, such as an IMU, a magnetometer a machine vision sensor, a smart scene sensor, a speech recognition sensor, an impact sensor, a shock sensor, a position sensor, a tilt sensor, etc.

In some aspects, the image sensors 501 of the XR device may include a left eye sensor and a right eye sensor, with each sensor being configured to track a plurality of ocular regions. For example, an image sensor 501 may track motion of an eye region and an eyebrow region. In this case, only two image sensors may be implemented by the XR device. Each image sensor 501 may be configured to have a larger FOV to increase the capture region, and each image sensor 501 is positioned in a location to capture sufficient detail to determine a gaze, biometric information for biometric authentication (e.g., iris information), and identify any biasing applied to the eyebrows by the user's various facial muscles (e.g., orbicularis oculi, temporalis, frontalis, corrugator supercilii, etc.). In one non-limiting aspect, the image sensor may be placed on a lower eyelid region and proximate to a lateral canthus of the user's eye. In this aspect, an image sensor may be oriented to capture images of the user's eye (e.g., pupil) and eyebrow. For example, an image sensor having a sufficiently wide field of view may be configured to capture the eye movement and the eyebrow movement.

As described previously, XR devices and/or systems can facilitate interactions between users and content in the XR environment. It may be useful to have techniques to determine when a user is fatigued, not interested in, or is distracted from the XR environment. Generally, eye tracking can provide information regarding user attentiveness, as the human eye has a relatively small area, or fovea, that has the highest visual acuity. Outside of a foveal area, visual acuity rapidly drops off. In some cases, foveated rendering may allow fovea areas of an image to be rendered with higher resolution than areas outside of the fovea areas (referred to as peripheral areas) that may be rendered with a lower resolution. In some cases, due to the higher resolution fovea areas and lower resolution peripheral areas, the eyes of a user may tend to move to focus the higher resolution foveal area towards environmental elements that are of interest. This eye movement may be due to either a conscious or unconscious decision of the user to look at the environmental elements. An amount of time and/or a number of times a user looks at an environmental element may indicate how much attention the user is paying to that environmental element. In accordance with aspects of the present disclosure, eye tracking data indicating which area(s) of an image at which a user is gazing may be compared to an ROI in the XR environment, or identified by the XR device, to determine information about user attentiveness to the XR environment.

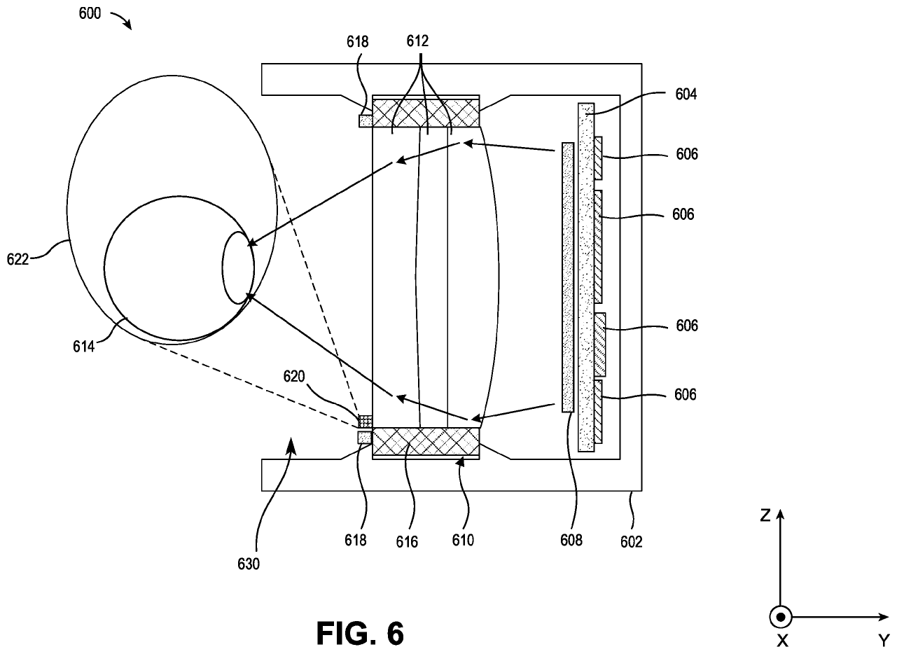

FIG. 6 is a block diagram illustrating a cross-sectional view of a lens assembly of an XR device 600 with at least one shared ocular region sensor (also referred to as an ocular sensor or image sensor), in accordance with some examples. While not shown, the XR device 600 can include one or more of the components of the XR device 500 of FIG. 5, such as one or more accelerometers, one or more gyroscopes, an ocular tracker, storage, compute components, an XR engine, an image processing engine, and a rendering engine, similar to those described with respect to FIG. 5. As shown in FIG. 6, the XR device 600 includes a housing 602 that provides mechanical support for other components. For example, the XR device 600 includes at least one printed circuit board (PCB) 604 that provides electrical connections to various integrated circuits 606 and a display 608. In some aspects, the display 608 may be attached to another PCB or other support structure. In this case, the display 608 may be configured as a single display or may be two separate displays that are separated. In this case, the display 608 is positioned at a far end of the housing 602. A near end of the housing 602 includes an opening that interfaces with a user's face and creates a closed environment that prevents external light (e.g., light not from the display 608) from entering the XR device 600.

The XR device 600 may include at least one optical assembly 610 that is configured to fasten one or more lenses 612 to the housing 602. In one example, a single optical assembly 610 may be configured to fasten the one or more lenses 612 to the housing. In another example, the XR device 600 may include an optical assembly 610 for each eye. The display 608 is configured to generate at least two planar 2D images and provide the planar 2D images to the one or more lenses 612, which focuses the 2D images into the user's eyes 614 to create a stereoscopic image (e.g., a 3D image) for the user. The optical assembly includes a ring 616 that is located around a circumference of the one or more lenses 612, and the ring 616 includes an illumination source including a plurality of light emitters 618 that are configured to emit a sufficient amount of light to illuminate the eye 614 and eyebrow region. In one illustrative aspect, the plurality of light emitters 618 may be configured to emit non-visible light to prevent interference with visible light emitted from the display 608.

In one illustrative aspect, the XR device 600 may include at least one image sensor 620 that is configured to capture images of the eye 614 and facial regions proximate to the eye 614. The XR device 600 can be configured to perform similar operations as those described with respect to the XR device of FIG. 5 based on the images captured by the at least one image sensor 620. For instance, the XR device 600 can run (or execute) XR applications and implement XR operations. In some cases, the XR device 600 can perform tracking and localization, mapping of an environment in the physical world (e.g., a scene), and/or positioning and rendering of virtual content on the display 608 as part of an XR experience. For example, the XR device 600 can generate a map (e.g., a three-dimensional (3D) map) of an environment in the physical world, track a pose (e.g., location and position) of the XR device 600 relative to the environment (e.g., relative to the 3D map of the environment), position and/or anchor virtual content in a specific location(s) on the map of the environment, and render the virtual content on the display 608 such that the virtual content appears to be at a location in the environment corresponding to the specific location on the map of the scene where the virtual content is positioned and/or anchored. The display 608 can include a glass, a screen, a lens, a projector, and/or another display mechanism that allows a user to see the real-world environment and also allows XR content to be overlaid, overlapped, blended with, or otherwise displayed thereon.

The XR device 600 includes a cavity region 630 to provide sufficient space distance between the eye 614 for optical reception. For example, the cavity region 630 may provide space for circulation of air and provide space to accommodate various features, such as glasses that are worn by the user. In some aspects, the image sensor(s) 620 may be configured to capture a region 622 that includes the eye 614 and an eyebrow region based on the cavity region, a FOV of the image sensor(s) 620, and an orientation of the image sensor(s) 620. In some aspects, the image sensor(s) 620 is configured to be positioned in a lower eye region that is below a vertical center point of the eye 614, and biased toward a lateral edge of the eye 614 (e.g., away from a center line of the user). For example, as shown in FIG. 6, a lower region may be the region below the lateral canthus and the medial canthus of the user's eye 614.

In some aspects, the light emitters 618 are IR emitters configured to emit IR light based on a current. In some cases, the light emitters 618 emitters can be placed along a planar surface in a circumferential arrangement on a constant pitch to provide even lighting to the eye 614. In some aspects, the illumination source can include a plurality of light source (e.g., light-emitting diodes (LEDs) arranged in series. For example, additional light source (e.g., LEDs, IR emitters, etc.) can be placed in series with existing light sources (e.g., existing LEDs, IR emitters, etc.). In such an example, there may be no need for additional safety circuit(s), device drivers, etc., as existing device safety circuit(s), drivers, etc. can be used. The light emitters 618 provide sufficient current to provide illumination of the eye 614 but do not provide sufficient illumination for the eyebrow region, as shown in FIG. 4A. In this case, light emitters 618 are transmitting IR light at a power that is limited for user safety. For example, eight (8) light emitters may be placed every 45° along the circumferential surface of the ring 616.

In some cases, the IR emitted by the light emitters 618 may not be sufficient to capture the eyebrow region. For example, the image sensor(s) 620 may have an exposure time of 250 microseconds (μs), and the eyebrow region may not be usable by objection detection engines to identify movement or biasing of the eyebrows. In some aspects, the light emitters 618 may be reconfigured to have an uneven pitch to provide additional light to an upper region associated with the eye. For example, two additional light emitters 618 may be placed within the upper 150 degrees (°) of the ring 616 (e.g., a pitch of 30°) to provide additional light to the eyebrow region, while the remaining are placed within the remaining 210° of the ring 616 (e.g., a pitch of 42°).

In some aspects, the image sensor(s) 620 may be reconfigured to control the exposure time to capture sufficient light. Reducing the exposure time, reduces motion blur and luminance of the image. Increasing the exposure time, increases motion blur and luminance of the image. A significant amount of motion blur may reduce the accuracy of gaze detection and eyebrow tracking. In some aspects, increasing the exposure time to a time between 600 μs to 2 milliseconds (ms) balances the motion blur with adequate exposure time to ensure the eyebrow region is captured with sufficient luminance for eyebrow detection tasks.

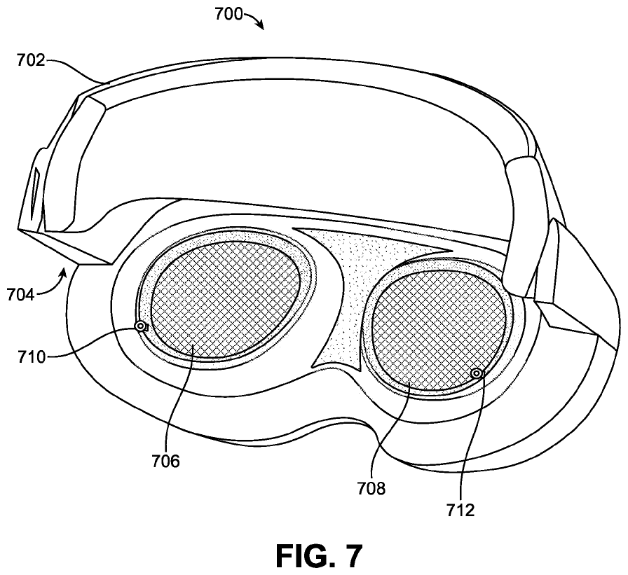

FIG. 7 is a perspective view of an XR device 700 with at least one shared ocular region sensor, in accordance with some examples. The XR device 700 is an example implementation of the XR device 600 of FIG. 6. The XR device 700 includes a housing 702 having a cavity 704 to ensure sufficient space within the XR device 700 for circulation and other objects such as glasses, etc. A left lens 706 is configured to provide images to a left eye of the user, and a right lens 708 is configured to provide images to a right eye of the user.

A left image sensor 710 is fastened (e.g., epoxied) to a surface of the left lens 706 and configured to capture images of the left eye and left eyebrow. A right image sensor 712 is fastened to a surface of the right lens 708 and configured to capture images of the right eye and right eyebrow. In some aspects, the left image sensor 710 and the right image sensor 712 each have a field of view of at least 90° to capture an image of the corresponding eye and eyebrow. As illustrated in FIG. 7, the left image sensor 710 and the right image sensor 712 are disposed in a lower eyelid region and are placed in proximity to a lateral canthus of the user.

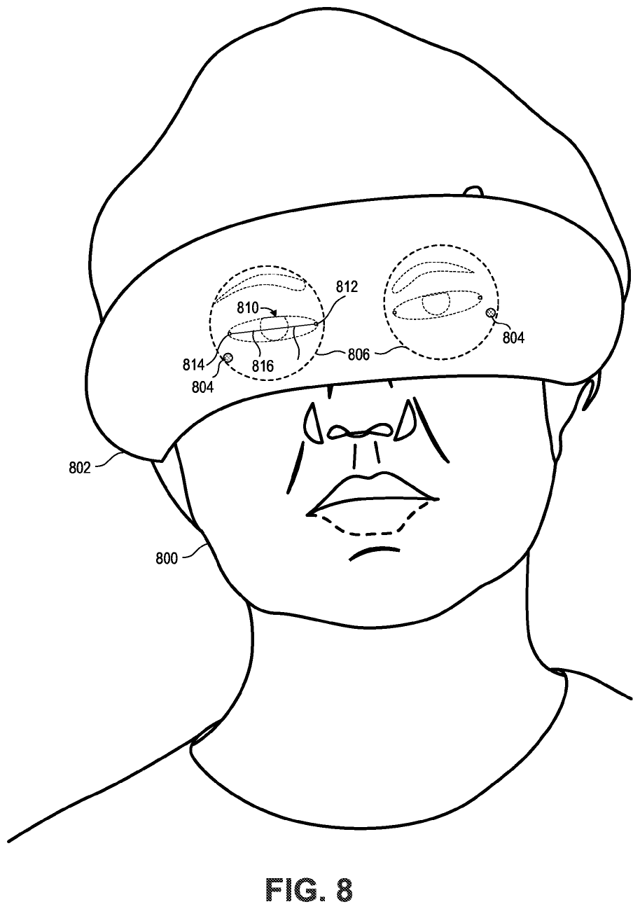

FIG. 8 is a conceptual diagram illustrating a position of at least one shared ocular region sensor that is integral to an XR device 802, in accordance with some examples. The XR device 802 is another example implementation of the XR device 600 of FIG. 6. In some aspects, a user 800 is wearing an XR device 802 including one or more image sensors 804 that are attached to a corresponding lens 806. In this illustrative example, each of the image sensors 804 are oriented to capture images including the user's eye and eyebrow region.

In some aspects, eyes 810 of the user are separated by an interpupillary distance, which varies from person to person. The optical assembly of the XR device 802 may be include a mechanical fixture that adjusts to a position of the lens 806 to align with the user's eyes 810. The user's eye 810 includes a medial canthus 812, which is a point at which anatomy of the eye intersects with anatomy of the nose, and a lateral canthus 814 at a distal end of the eye 810. A center line 816 from the medial canthus 812 to the lateral canthus 814 separates an upper eyelid region from a lower eyelid region. The image sensors 804 are attached to the lens and their position may be adjusted based on the optical assembly such that the image sensors 804 are positioned in a location sufficient to capture images of the eyes 810 of the user.

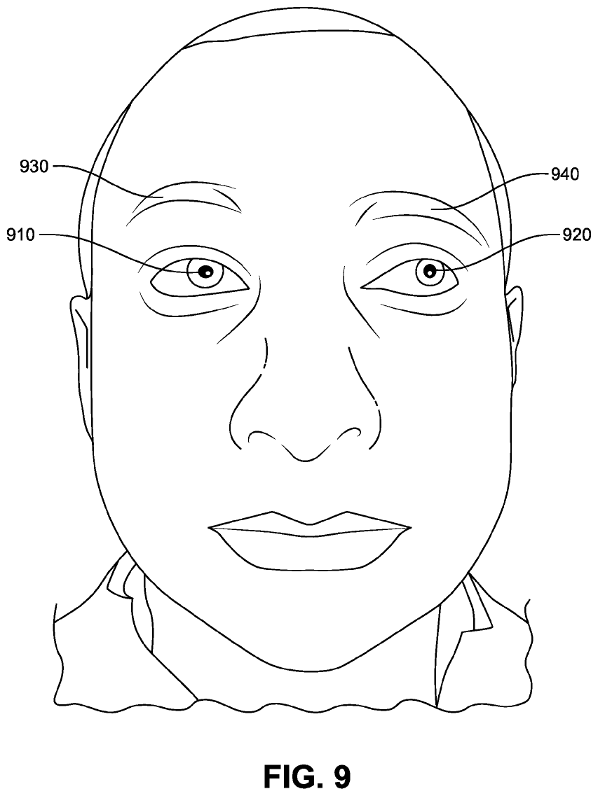

FIG. 9 is an image of a user and illustrates facial expressions that can be detected by an XR device with a shared ocular region sensor, in accordance with some examples. In this case, the user may be rolling their eyes to express disbelief, and ocular motion of a right eye 910 and a left eye 920 can be detected by a shared ocular region sensor for the left eye and a shared ocular region sensor for the right eye. The shared ocular region sensors may also simultaneously capture images of biasing of a right eyebrow region 930 and a left eyebrow region 940. In this illustrated example, the frontalis muscles are biased to cause the eyebrows to raise upwards toward the forehead. In some aspects, the shared ocular region sensors can detect any suitable movement, such as raising, lowering, inward movement, outward movement, and rotation.

In some aspects, an image including both eye features and eyebrow features may simplify processing of gaze detection and facial expression detection. In some aspects, the gaze detection and facial expression can be mapped into an XR social environment and applied to a user avatar such that other users within the XR social environment can understand the non-verbal communication. Providing detail and non-verbal communication is an important aspect to create an engaging and meaningful experience in XR social environments. Although the aspects described above relate to XR social environments, the XR environments can be any suitable XR environment, such as a business meeting, an entertainment environment, and so forth.

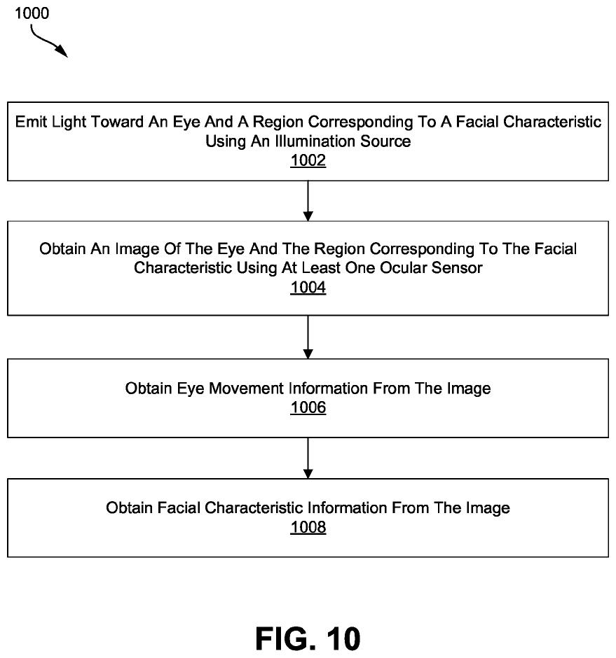

FIG. 10 is a flow chart illustrating an example of a process 900 for image processing. The process 1000 can be performed by an XR device (e.g., the XR device 500 of FIG. 5, XR device 600 of FIG. 6, XR device 700 of FIG. 7, XR device 802 of FIG. 8, or other device) or by a component or system (e.g., a chipset, a system-on-chip (SoC), one or more processors such as one or more CPUs, GPUs, DSPs, etc.) of the XR device. In one or more examples, the XR device may be implemented within (e.g., housed within), communicatively connected to, and/or associated with another device or system. The operations of the process 1000 may be implemented as software components that are executed and run on one or more processors (e.g., image processor 250 of FIG. 2, one or more of the compute components 510 of FIG. 5, processor 1110 of FIG. 11, or other processor(s)), which may be implemented within the camera and/or the device.

At block 1002, the XR device (or component thereof) can emit light toward an eye and a region corresponding to a facial characteristic using an illumination source (e.g., the illumination source of the XR device 600 of FIG. 6 or other illumination source). In some cases, the illumination source includes at least one ring circumferentially disposed around at least one lens (e.g., the ring 616 located around a circumference of the one or more lenses 612 of the XR device 600 of FIG. 6). In such cases, a plurality of infrared light sources are disposed on the at least one ring to illuminate a pupil and the region corresponding to the facial characteristic.

At block 1004, the XR device (or component thereof) can obtain an image of the eye and the region corresponding to the facial characteristic using at least one ocular sensor (e.g., the at least one image sensor 620 of FIG. 6, the left image sensor 710 and/or the right image sensor 712 of FIG. 7, at least one of the image sensors 804 of FIG. 8, or other ocular sensor). In some aspects, the illumination source is configured to emit light in the infrared spectrum and the at least one ocular sensor is configured to capture light in an infrared spectrum. Additionally or alternatively, in some cases, the illumination source is an LED light source and the at least one ocular sensor can capture LED light. In some aspects, the at least one ocular sensor includes a single left ocular sensor configured to track left eye and left eyebrow movement and a single right ocular sensor configured to track right eye and right eyebrow movement, such as that discussed with respect to the XR device 500 of FIG. 5, the XR device 600 of FIG. 6, the XR device 700 of FIG. 7, and/or the XR device 802 of FIG. 8. In some aspects, the at least one ocular sensor is positioned in a lower eyelid region and proximate to a lateral canthus. In some examples, a field of view of the at least one ocular sensor is at least 90 degrees (90°). In some cases, an exposure time of the at least one ocular sensor is greater than 500 microseconds and less than 2 milliseconds.

At block 1006, the XR device (or component thereof) can obtain eye movement information from the image. At block 1008, the XR device (or component thereof) can obtain facial characteristic information from the image. For instance, as described with respect to the XR device 500 of FIG. 5, the XR device can use the eye movement information and the facial characteristic information form the image to perform one or more functions, such as to determine when a user is fatigued, not interested in, or is distracted from the XR environment (e.g., virtual content displayed as part of the XR environment).

FIG. 11 is a diagram illustrating an example of a system for implementing certain aspects of the present technology. In particular, FIG. 11 illustrates an example of computing system 1100, which can be for example any computing device making up internal computing system, a remote computing system, a camera, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some aspects, computing system 1100 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 1100 includes at least one processing unit (CPU or processor) 1110 and connection 1105 that couples various system components including system memory 1115, such as ROM 1120 and RAM 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some aspects, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An extended reality (XR) apparatus, comprising: a housing configured to interface with a face of a user; at least one display configured to output an image, wherein the at least one display is disposed at a far end of the housing with respect to the face; at least one optical assembly fastened to the at least one display; at least one lens fastened to the at least one optical assembly and configured to focus the image for a corresponding eye; at least one ocular sensor attached to a near surface of the at least one lens and configured to obtain images to track eye movement and a facial characteristic of the user, and an illumination source configured to illuminate a region corresponding to the eye and a region corresponding to the facial characteristic.

Aspect 2. The XR apparatus of Aspect 1, wherein the at least one ocular sensor comprises a single left ocular sensor configured to track left eye and left eyebrow movement and a single right ocular sensor configured to track right eye and right eyebrow movement.

Aspect 3. The XR apparatus of any of Aspects 1 to 2, wherein the at least one ocular sensor is configured to capture light in an infrared spectrum.

Aspect 4. The XR apparatus of Aspect 3, wherein the illumination source is configured to emit light in the infrared spectrum.

Aspect 5. The XR apparatus of Aspect 4, wherein the illumination source comprises at least one ring circumferentially disposed around the at least one lens, and wherein a plurality of infrared light sources are disposed on the at least one ring to illuminate a pupil and the region corresponding to the facial characteristic.

Aspect 6. The XR apparatus of any of Aspects 1 to 5, wherein the at least one ocular sensor is positioned in a lower eyelid region and proximate to a lateral canthus.

Aspect 7. The XR apparatus of any of Aspects 1 to 6, wherein a field of view of the at least one ocular sensor is at least 90 degrees (90°).

Aspect 8. The XR apparatus of any of Aspects 1 to 7, wherein an exposure time of the at least one ocular sensor is greater than 500 microseconds and less than 2 milliseconds.

Aspect 9. A method of capturing an image in an XR apparatus, comprising: emitting light toward an eye and a region corresponding to a facial characteristic using an illumination source; obtaining an image of the eye and the region corresponding to the facial characteristic using at least one ocular sensor.

Aspect 10. The method of Aspect 9, wherein the at least one ocular sensor comprises a single left ocular sensor configured to track left eye and left eyebrow movement and a single right ocular sensor configured to track right eye and right eyebrow movement.

Aspect 11. The method of any of Aspects 9 to 10, wherein the at least one ocular sensor is configured to capture light in an infrared spectrum.

Aspect 12. The method of Aspect 11, wherein the illumination source is configured to emit light in the infrared spectrum.

Aspect 13. The method of Aspect 12, wherein the illumination source comprises at least one ring circumferentially disposed around at least one lens, and wherein a plurality of infrared light sources are disposed on the at least one ring to illuminate a pupil and the region corresponding to the facial characteristic.

Aspect 14. The method of any of Aspects 9 to 13, wherein the at least one ocular sensor is positioned in a lower eyelid region and proximate to a lateral canthus.

Aspect 15. The method of any of Aspects 9 to 14, wherein a field of view of the at least one ocular sensor is at least 90 degrees (90°).

Aspect 16. The method of any of Aspects 9 to 15, wherein an exposure time of the at least one ocular sensor is greater than 500 microseconds and less than 2 milliseconds.

Aspect 17. An XR apparatus, comprising at least one memory and at least one processor coupled to the at least one memory and configured to perform operations according to any of Aspects 9 to 16.

Aspect 18. A non-transitory computer-readable medium having stored thereon instructions that, when executed by at least one processor, cause the at least one processor to perform operations according to any of Aspects 9 to 16.

Aspect 19. An XR apparatus, comprising one or more means for performing operations according to any of Aspects 9 to 16.

1. An extended reality (XR) apparatus, comprising:
a housing configured to interface with a face of a user;
at least one display configured to output an image, wherein the at least one display is disposed at a far end of the housing with respect to the face;
at least one optical assembly fastened to the at least one display;
at least one lens fastened to the at least one optical assembly and configured to focus the image for at least one eye;
at least one ocular sensor attached to a near surface of the at least one lens and configured to obtain images to track eye movement of the at least one eye and a facial characteristic of the user; and
an illumination source configured to illuminate a region corresponding to the at least one eye and a region corresponding to the facial characteristic.

2. The XR apparatus of claim 1, wherein the at least one eye includes a left eye and a right eye, and wherein the at least one ocular sensor comprises a single left ocular sensor configured to track left eye and left eyebrow movement and a single right ocular sensor configured to track right eye and right eyebrow movement.

3. The XR apparatus of claim 1, wherein the at least one ocular sensor is configured to capture light in an infrared spectrum.

4. The XR apparatus of claim 3, wherein the illumination source is configured to emit light in the infrared spectrum.

5. The XR apparatus of claim 4, wherein the illumination source comprises at least one ring circumferentially disposed around the at least one lens, and wherein a plurality of infrared light sources are disposed on the at least one ring to illuminate a pupil and the region corresponding to the facial characteristic.

6. The XR apparatus of claim 1, wherein the at least one ocular sensor is positioned in a lower eyelid region and proximate to a lateral canthus.

7. The XR apparatus of claim 1, wherein a field of view of the at least one ocular sensor is at least 90 degrees (90°).

8. The XR apparatus of claim 1, wherein an exposure time of the at least one ocular sensor is greater than 500 microseconds and less than 2 milliseconds.

9. The XR apparatus of claim 1, wherein the illumination source comprises a plurality of light-emitting diodes (LEDs) arranged in series.

10. The XR apparatus of claim 1, further comprising at least one processor, wherein:
the illumination source is configured to emit light toward the region corresponding to the at least one eye and the region corresponding to the facial characteristic; and
the at least one processor is configured to:
obtain an image of the at least one eye and the region corresponding to the facial characteristic using at least one ocular sensor;
obtain eye movement information from the image; and
obtain facial characteristic information from the image.

11. A method of capturing an image in an XR apparatus, comprising:
emitting light toward an eye and a region corresponding to a facial characteristic using an illumination source;
obtaining an image of the eye and the region corresponding to the facial characteristic using at least one ocular sensor;
obtaining eye movement information from the image; and
obtaining facial characteristic information from the image.

12. The method of claim 11, wherein the at least one ocular sensor comprises a single left ocular sensor configured to track left eye and left eyebrow movement and a single right ocular sensor configured to track right eye and right eyebrow movement.

13. The method of claim 11, wherein the at least one ocular sensor is configured to capture light in an infrared spectrum.

14. The method of claim 13, wherein the illumination source is configured to emit light in the infrared spectrum.

15. The method of claim 14, wherein the illumination source comprises at least one ring circumferentially disposed around at least one lens, and wherein a plurality of infrared light sources are disposed on the at least one ring to illuminate a pupil and the region corresponding to the facial characteristic.

16. The method of claim 11, wherein the at least one ocular sensor is positioned in a lower eyelid region and proximate to a lateral canthus.

17. (canceled)

18. (canceled)

19. An extended reality (XR) apparatus for tracking eye movement and facial expressions, the XR apparatus comprising:
at least one memory;
an illumination source configured to emit light toward an eye and a region corresponding to a facial characteristic;
at least one ocular sensor configured to obtain an image of the eye and the region corresponding to the facial characteristic; and
at least one processor coupled to the at least one memory and the illumination source, the at least one processor configured to:
obtain eye movement information from the image; and
obtain facial characteristic information from the image.

20. The XR apparatus of claim 19, wherein the at least one ocular sensor comprises a single left ocular sensor configured to track left eye and left eyebrow movement and a single right ocular sensor configured to track right eye and right eyebrow movement.

21-22. (canceled)

23. The XR apparatus of claim 22, wherein the illumination source comprises at least one ring circumferentially disposed around at least one lens, and wherein a plurality of infrared light sources are disposed on the at least one ring to illuminate a pupil and the region corresponding to the facial characteristic.

24. The XR apparatus of claim 19, wherein the at least one ocular sensor is positioned in a lower eyelid region and proximate to a lateral canthus.

25-26. (canceled)
